(19) United States
(12) Patent Application Publication
(10) Pub. No.: US 2002/0013782 A1
(43) Pub. Date: Jan. 31, 2002

(54) Software program for internet information retrieval, analysis and presentation

(76) Inventors: Daniel Ostroff, Kiryat Yearim (IL); Jeffrey Gale, Kiryat Yearim (IL); Joseph S. Friedman, Olney, MD (US)

Correspondence Address: James P Hao, Wagner Murabito & Hao LLP, Two North Market Street, Third Floor, San Jose, CA, 95113, US

(21) Appl. No.: 09/783,318

(22) Filed: Feb. 15, 2001

Related U.S. Application Data
(60) Provisional application No. 60/183,366, filed on Feb. 18, 2000.

(51) Int. Cl. G06F 17/30

(52) U.S. Cl. 707/10; 707/3

(57) ABSTRACT

A method and system for generating reports relating to various web sites. Each report will be tailored to the type of web sites examined as well as the particular client. A site structure description language as well as content standardization rules will be employed by one or more intelligent agent Bots to analyze the information provided on the web pages. This information will be transmitted to a data warehouse for analysis by a report analysis system. A report presentation system along with a user graphical interface will allow each particular client to view their particular reports. Among other features, these reports would indicate the position of the web site and a particular search engine as well as the number of clicks it would take to order a particular product or service.

### CORRESPONDING APPLICATION

The present application is entitled to the benefit of Provisional Patent Application Ser. No. 60/183,366 filed on Feb. 18, 2000.

### FIELD OF THE INVENTION

The present invention is directed to a system and method of tracking, gathering and presenting information relating to data on the Internet, including, but not limited to data residing on Internet web sites.

### BACKGROUND OF THE INVENTION

The Internet has recently been called one of the fastest-growing commercial phenomena ever witnessed by society. According to Nielsen/NetRatings, more than 295 million people worldwide have Internet access from a home computer, about half of them in the United States.

The Internet is a repository for vast quantities of information of almost any kind. Many of these kinds of information exist at all times at specific, known locations on the Internet, but change frequently in value or content. This invention addresses the need, for some users of the Internet, to monitor and analyze this type of information continually on a large scale.

One of the important uses of the Internet is as a retail tool. According to a recent report by eMarketer, by the end of 2000, the number of Internet shoppers in the U.S. will reach an estimated 63 million. The On-line e-commerce marketplace market is divided into business-to-consumer sales (B2C) and business-to-business sales (B2B). The B2C market was estimated to be approximately $29 billion in 2000, and is continuing to grow. According to the U.S. Department of Commerce, e-commerce sales in the 3^{rd} quarter of 2000 increased by 15% from the 2^{nd} quarter of 2000. B2B e-commerce was estimated to be 336 billion in 2000. According to Forrester Research, by 2004, the e-commerce market is expected to be 6.8 trillion, with 3.5 trillion from North America.

In the on-line retail marketplace, the need to continuously and comprehensively monitor one's competitors is essential. Firstly, the nature of the competition on the web is different than at a “bricks and mortar” store. A “bricks and mortar” store's competition is generally limited to similar stores within a geographically defined area. On the Internet an online retailer (e-tailer) in the United States must compete with e-tailers all over the United States and depending on the product, sometimes with e-tailers all over the world. Furthermore, the barriers to entry to start an on-line store are relatively low. This opens up the marketplace to a great many e-tailers, much more so that for a physical store where the prohibitive costs of starting-up the business limits the number of competitors.

Lastly, the relative ease with which an on-line customer can comparison-shop creates a buyers market in which it is difficult for an e-tailer to create any customer loyalty. In fact, Jupiter Communications reports that the average on-line customer visits three on-line stores to compare prices before making a purchase. In this aggressive on-line marketplace the importance of competitive intelligence cannot be overestimated.

Some of the criteria that a customer will use to choose at which on-line store to buy, outside of pricing, are search engine placement and the ease at which the customer can navigate the on-line store. As the number of web sites has grown exponentially, search services, called search engines have arisen as the key entry points to the Internet for the millions of users searching for content among the hundreds of millions of sites on the web.

A customer usually finds an item or service by utilizing a search engine, a series of programs that search the Internet and categorize items so that they can be found easily. A customer will input the product or service into the search engine and it will respond with a list of answers. Different search services use diverse factors to determine the ranking of a particular web site on the list. It is essential that an e-tailers be listed at the top of the search engine's list because customers will usually start their comparative pricing by working their way down the list. If one's on-line store is at the top of the list and the store fulfills the other customer buying criteria, then the sale will be consummated. An e-tailer can improve its chances of being placed at the top of the list by utilizing techniques that are well known to web site designers.

Another important element in a customer's purchasing choice is the ease with which the customer can navigate around the e-tailer's site and purchase the item. Ideally, there should be only a minimal amount of “clicks” by the customer until the item is purchased.

The relative ease with which an e-tailer can make changes to their site, affecting price, promotions or product catalogue makes it all the more important to monitor one's competitors so that they can act rapidly to make any changes in response. Therefore, it is essential for an on-line retailer who wishes to maintain a competitive edge to continuously and comprehensively monitor their rivals' Internet sites.

Comparison-shopping services like My Simon and Dealtime only gather a few kinds of information, such as price and availability of products. The information that they provide is often incomplete, only some examples of any given product are provided and the products are often selected in a random way. They often include irrelevant data and false matches. This is because they use “spider” technology that searches Internet with only limited advanced understanding of the web pages observed. Existing technologies are specialized to service consumers, not merchandisers or marketers.

Companies such as NetPeriscope.com and RivalWatch offer e-tailers competitive intelligence services. However, they only provide information regarding pricing, promotions and product catalogue and shipping. They do not have the capability to provide information regarding search engine positioning or navigational speed and efficiency. Additionally, NetPeriscope is limited to providing information about certain specific industries. Consequently, it could not be utilized by a number of businesses.

KhiMetrics gives a recommended price based on the e-tailer's data aand the competition's prices. It is a tool to match the e-tailer's products against the competition. However, it does not provide information regarding web topology, shipping and web positions.

Caesuis Software offers a software package called WebQL with which you can query the Internet and obtain some competitive intelligence information.

CurrentAnalysis provides on-line intelligence reports to its clients. Its service is limited to reporting on significant industry developments which they call, “tactical event intelligence” such as information regarding product announcements and mergers and acquisitions. Similarly, NetCurrents provides clients with intelligence information.

There are also companies such as Hi-Positions that will inform on-line web sites of their relative placement on the search engines. However, these services are limited only to search engine placement. They do not provide competitive intelligence information regarding pricing, products or any other aspects of the competitors' merchandising policies. This company is designed for use by entrepreneurs, for technicians to improve specific search results, not as a tool for gaining broad market view summary information.

### SUMMARY OF THE INVENTION

The deficiencies of the prior art are addressed by the present invention which is directed to a system and method for the analysis of various web pages provided on the Internet to provide comprehensive intelligence reports to interested parties including, but not limited to on-line retailers, wholesalers, government agencies and research firms. It is noted that the purpose of the present invention is not directed to private Internet consumers.

The present invention is designed to retrieve, harvest, decode, store, analyze and correlate public information web site data from the Internet to create an automated micro-management written or electronic report for on-line retail businesses, e-tailers and on-line wholesale businesses to give them competitive intelligence or advantages over the prior art.

The present invention would employ web agent technology, “Bot” and “crawler” technology, artificial intelligence, data fusion technology, HTML, XTML, rule base technology, pattern recognition, key word proportional placement, linkage, deep linkage technology and other technologies as well as mathematical formulas or algorithms to simulate human reasoning. The pattern matching and recognition aspect of the present invention would be used to model the structure of an Internet site. The would enable site controllers to easily profile a web site.

The present invention would deliver expert reports based upon targeted information gathered from the Internet. The information is targeted using detailed and complete human-aided analysis of large numbers of Internet resources to determine how to locate specific kinds of data. This information is gathered and stored in a high speed, continual and automated manner and the data for the reports is produced by assemblies of components, each of which retrieves and processes stored information. The produced reports are delivered on demand in user-friendly format via the Internet.

The present invention utilizes an automated software program that will provide comprehensive and continuous monitoring of specific targeted sites, such as an e-tailers competitor's sites. The invention will provide with reports based on automated analysis of the information gathered during the monitoring process. In the case of e-tailers, it will provide information regarding diverse areas of their rival's site including, their pricing, their product catalog, the structure and design of their site and the placement of their site in search engine lists.

The present invention would provide comprehensive daily intelligence reports to on-line retailer, wholesale or portal businesses and government agencies via customized Internet portal web pages and e-mail notification.

The present invention would utilize these reports to provide customized trend analysis reports. The present invention would thus enable e-tailers to determine their rival's primary focus and strategy, and would enable them to answer many important questions regarding their competition.

Among the questions that the present invention would answer would be directed to their competitor's marketing strategy, their competitor's product mix, what products have been added or deleted from their competitor's product site. Furthermore, the present invention would allow the e-tailer to determine whether specific items appear on their rival's site and how the rivals are promoting and shipping their products.

Furthermore, the present invention would allow an e-tailer to determine their rival's ranking on popular search engines as well as how many clicks does it take, on average, to obtain a product from a certain department. The present invention would monitor, report and provide trend analysis for the above site information utilizing an automated process, thereby enabling e-tailers to save a significant amount of time, money and resources.

A principal object of the present invention lies in its automated and comprehensive nature. The present invention is the only system that can capture a whole array of competitive intelligence. It is not limited to pricing or products, but provides clear concise reports navigational ease and search engine placement.

In its preferred embodiment, the present invention will provide comprehensive daily intelligence reports to on-line retail, wholesale or portal businesses and governmental agencies via customized Internet portal web pages and e-mail identification. Utilizing document analysis, reports are provided to the on-line agency the results of the automated software program. Additionally, it is noted that human intervention can also be employed to use configuration utilities to configure position analysis of web sites designated for monitoring.

Each application gathers data automatically on a daily basis to provide card reports and stores all data collected to provide customized trend analysis reports. Additionally, the present invention amalgamates all data to create a macroeconomic statistic and trend storage bank.

These and other objects and advantages of the present invention will become apparent to one skilled in the art to which the invention pertains in the following detailed description when read in conjunction with the appended drawings.

### BRIEF DESCRIPTION OF THE DRAWINGS

FIG. 1 is a block diagrams of the manner in which an SSDL site description is used to analyze an Internet site;

FIG. 2 is a block diagram showing the manner in which content standardization rules are created for an Internet site;

FIG. 3 shows a block diagram of an intelligent agent Bot gathering information from an Internet site;

FIG. 4 illustrates a block diagram of the date interpreter interpreting gathered information; and

FIG. 5 is a block diagram of the report protection system.

### DETAILED DESCRIPTION OF THE INVENTION

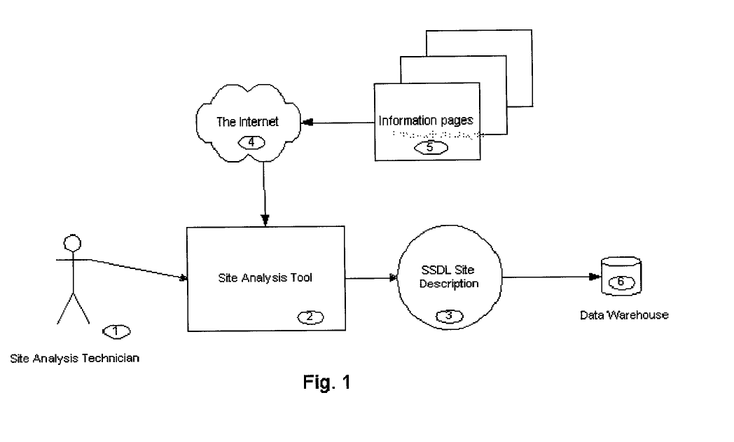

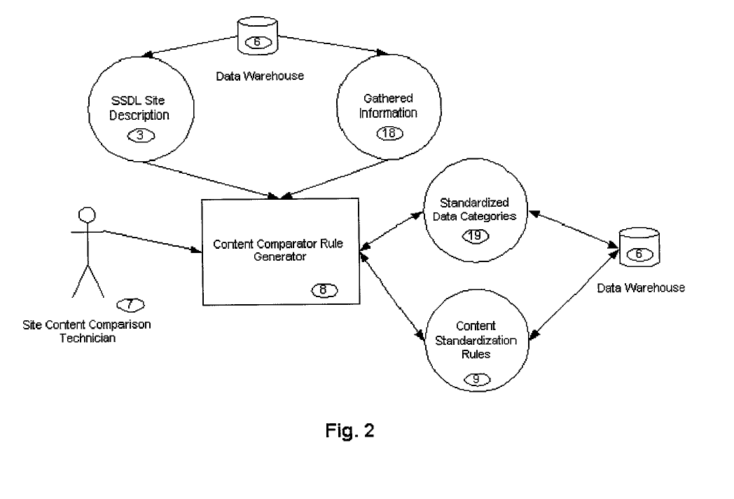

The present invention is described in FIGS. 1-5 with like components keeping the same reference numeral.

The purpose of the present invention as shown in FIG. 1, is to analyze various informational web pages 5 provided on the Internet 4. A site analysis technician 1 as well as a site content comparison technician 7 would be utilized to enhance the automated nature of the present invention. The present invention would utilize a pattern-matching language for modeling the HTML or XTML structure of an Internet site including the information included in the web pages 5. A site analysis tool 2 would be used by the site analysis technician 1 which is a computer software and hardware subsystem used to create a site structure description language (SSDL) of an Internet site quickly and easily, using a graphical interface.

The SSDL is a specification of a formal language that is used to describe a web site or other information service consisting of a navigeable collection of Internet resources, known as pages 5. The SSDL description details the structure of the information in each page, the location of targeted information on each page in terms of their structure, the navigation topology of the site and similarities in structure between the pagers. The SSDL describes these aspects of site in terms of parameters that tend to remain constant even when minor changes are made to a site over time.

It is important that the reports generated utilizing the present invention can compare corresponding items on various sites, e.g., the price of the same item on various competing e-tail sites. Although it may be apparent to an expert human eye that text or other kinds of data on different sites refer to the same item, they are often different enough from each other that they can not be matched with each other as they are by a computer program. Consequently, the site content comparison technician 7 would utilize a content comparator rule generator 8 to provide content standardization rules 9. The content standardization rules specify a set of data transmissions for each site that express the data gathered from that site in a standardized, canonical format. After being transformed using the content standardization rules, all data from all sites are expressed in a standard format and items can be compared by computer program for matches. The content standardization rules 9 are provided by a content comparator rule generator 8 which is a computer software and hardware subsystem that aids technicians to create the content standardization rules for a site quickly and easily, using a graphical interface.

The data which is generated utilizing the site analysis tool 2, the SSDL site 3, the content comparator rule generator 8, as well as the content standardization rules 9 would be transmitted to the data warehouse 6. The data warehouse 6 is a data storage facility that amasses current and historical data and makes it available for generating the appropriate reports. The data warehouse 6 consists of data storage hardware and software distributed across several computers at different locations, replication technology, data schema that describe all the kinds of data being stored, and logical relationships between them. Additionally, the data warehouse 6 would include a software library shared by all of the components of the present system for storing, querying and retrieving data from the data warehouse 6 in a standardized manner.

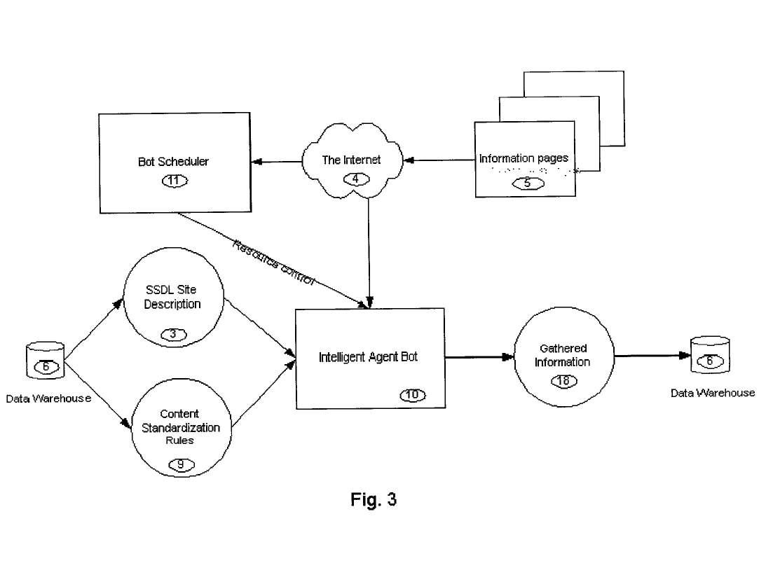

FIG. 3 illustrates in more detail the manner in which information is gathered for the various web pages 5 over the Internet 4. An intelligent agent Bot 10 utilizes the SSDL descriptions 3 as well as the content standardization rules 9 to automatically gather information from the Internet sites. The intelligent agent Bot gathers target information described in the SSDL and also records changes to the site navigation topology and to the structure of the pages on the site. As shown in FIG. 3, the SSDL site description 3 as well as the content standardization rules 9 are stored in the data warehouse 6. Information 18 gathered by the intelligent agent Bot 10 is also stored in the date warehouse 6.

The intelligent agent Bot 10 employs a Bot scheduler 11 which is a computer software and hardware subsystem for managing and controlling usage of computing and communications resources by one or more of the intelligent agent Bots 10 connected in a distributed network. The Bot scheduler 11 ensures that the information being gathered is accessed in a manner indistinguishable from a human user, distributes usage of the intelligent agent Bots among the kinds of information that are of greater or lesser importance or that change more or less frequently. The Bot scheduler 11 would balance workload among the intelligent agent Bots and assures that all recorded information is gathered in a timely fashion.

The intelligent agent Bot 10 bases both its recognition of information and its navigation among web pages on the hierarchical structure of the code sent by the Internet site to represent a particular page. It uses our new formal site description language, site structure description language (SSDL), to guide its process of moving from web page to web page and recognizing and recording information on each page.

When searching for targeted information on a web page, the intelligent agent Bot 10 matches patterns against the hierarchical tree structure of the document representing the page in HTML, XML, WML, or other presentation or formatting language. This makes the intelligent agent Bot resilient to changes on the pages.

The intelligent agent Bot uses matched patterns on a page, rather than literal Internet addresses, to move from one page to another. This produces a view of the interconnection topology between the pages that is more faithful to the human browsing experience, and that is more resilient to changes on the pages.

SSDL allows the intelligent agent Bot 10 to use the same code for gathering information and following links from pages that are similar to each other in structure. Typically, web sites are generated by automated software, so even large web sites with many pages have the property that all of the pages fit into one of only a few patterns. By exploiting this fact, SSDL greatly reduces the amount of time needed to configure the intelligent agent Bot to gather information from any particular Internet site.

The site structure description language including:

a framework for listing a set of page types for each Internet site, and associating three sets of rules to each page type. These rules include feature rules that specify information on the page that uniquely identifies each page that belongs to the page type, information rules that specify information on the page that is to be recorded, and link rules that specify how to find hyperlinks from a page of this type to other pages;

a rule language syntax that combines various kinds of words (described below) into rules;

a set of relation words that describe structural relationships between elements of a page described in HTML or other presentation languages;

a set of matching words that describe how to match textual patterns with the content of the page, or within the tags that describe the structure of the page;

a set of building words that allow words and rules to be combined together to form more complex rules, using Boolean logic and aggregation logic; and

a mark word that designates part of a matched pattern as being significant for action commands described below.

The action commands that instruct the intelligent agent Bot 10 to take action the part of a matched pattern which is designated as being significant using a mark word. The action that the intelligent agent Bot takes depends on the type of rule. For a feature rule, the intelligent agent Bot adds the marked information to the identity of the pages. For a information rule, the intelligent agent Bot 10 records the marked information in the data warehouse 6. For a link rule, the intelligent agent Bot adds the hyperlink represented by the marked information to the list of further pages to be examined, and records information about the link in the data warehouse.

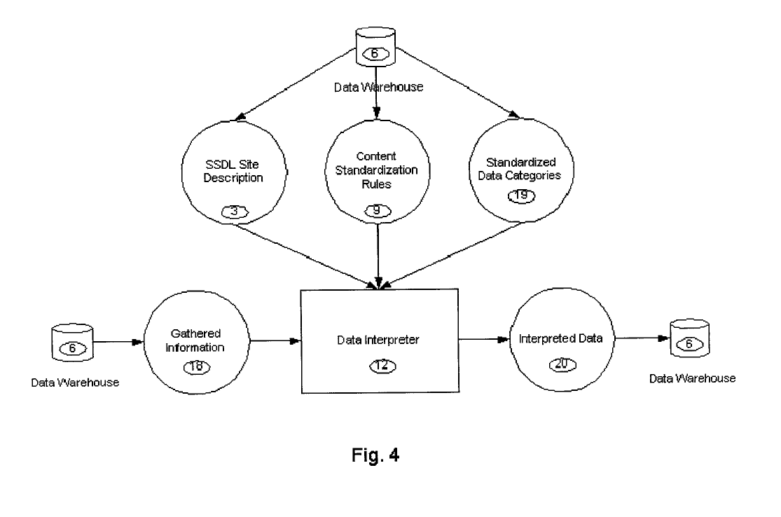

Referring to FIG. 4, a data interpreter 12 is used to interpret data stored in the data warehouse 6. The data interpreter 12 is a computer software and hardware subsystem that interprets and classifies the data gathered by the intelligent agent Bots as well as apply content standardization rules, store the information in the data warehouse 6, and provide feedback for adjustments to the SSDL descriptions of the sites and the content standardization rules. The interpreted data 20 is also stored in the appropriate location in the data warehouse 20.

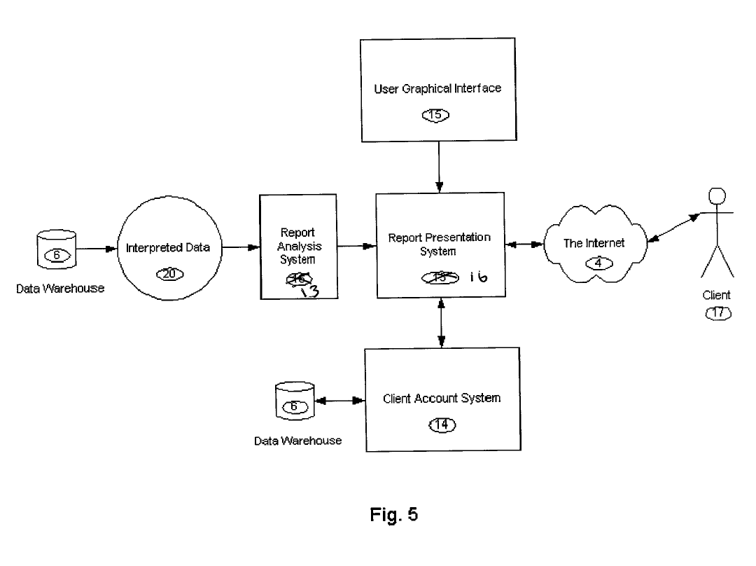

FIG. 5 illustrates the manner in which the information gathered in the data warehouse 6 employing the intelligent agent Bots 10 and the Bot schedule 11 would be presented to a client 17.

After the appropriate data has been gathered and interpreted, a report analysis system 13 would utilize the information contained in the data warehouse 6 for the purpose of generating the appropriate reports. The report analysis system 13 is capable of delivering one or more specific kinds of information by retrieving data from the data warehouse 6, processing it, interpreting it and rendering the result in the form of an electronic data structure ready to be included in a report. Various components employed in the report analysis system would be used to produce various types of reports. The report analysis system is capable of producing data in both tabular format as well as graphs.

A client account system 14 is a data storage system for tracking the identity of the various clients, as well as configuration information for each client that determines what reports are appropriate for which client to see and the particular configuration of the information provided in the report.

A report presentation system 16 is a computer software and hardware subsystem that manages sessions in which a user can view reports utilizing a user graphical interface 15. The report presentation system 16 verifies the identity of a client and determines which reports are appropriate for that client using the client account system 14. The report presentation system 16 would obtain data for the reports using the report analysis system 13, would format them for viewing and arrange their layout on a page according to the user's particular graphical interface 15. This interface would provide a set of graphic design, presentation design and user computer interaction design that together provides a consistent, intuitive and esthetic interface between the present invention and a particular client. The information is provided to the client in many ways such as delivering it to a particular web server. The report presentation system 16 also provides a manner for clients and system administrators to view and modify information in the client account system 14. The report presentation system includes security mechanisms that protect against unauthorized use of the data generated by the present invention.

The present invention is a tool for providing competitive merchandising intelligent to e-tailers. The report analysis and report presentations systems provide a set of comprehensive reports. Some of the reports uniquely utilize promotional intensity and a search engine index.

Promotional intensity is a number on a scale of 0 to 100 that indicates the intensity with an e-tailer site is promoting a particular item for sale. It is computed as a weighted composite normalized average of the number of pages on which the item appears, the height of placement of the item on the page, the amount of space on the page allocated to the item, special fonts describing the item, the number of pages with links to the item and the placement on the page of each link. The promotional intensity is raised if the item is on special. Zero indicates lowest intensity and 100 indicates highest intensity.

The search engine index is a weighted average of rankings of the client on various search engines for various search criteria. The selection of search criteria, search engines, and weighting factors is configurable according to the needs of the client.

Although the exact types of information provided to a client 17 would vary dependent upon the client's need and the types of web sites which the client desires reports, the type of information which could be utilized in the report could include information relating to a product catalog, special sales events, shipping charges and methods of shipping, a return policy, a discount policy, web site topology, merchandising strategy, site speed, broken links, membership requirements, Internet advertising pricing policy, technical tools used on a particular site, web position on the search engines and price as well as price lists for products.

The method of the present invention utilizing the teachings of the system shown in FIGS. 1-5 will now be described.

Each time a new Internet site is to be added to a list of sites from which data is to be gathered, the site analysis technician 1 would utilize the site analysis tool 2 to create a SSDL site description 3 describing that particular Internet site. This SSDL site description would be stored in a location of the data warehouse 6. The intelligent agent Bot 10 would then begin gathering information from each of the Internet web sites at regularly scheduled time intervals that are configured by a system administrator. Typically, a full cycle of gathering information will be completed each week for each Internet site. However, it can be appreciated that this scheduled time interval can be altered depending upon the interest of the client 17. The intelligent agent BOT 10 would use the SSDL site description 3 to determine what kinds of information to gather from the Internet site, which pages of a site to find each kind of information, and where on the page to find this information. The intelligent agent Bot 10 would store this gathered information 18 in a special area of the data warehouse 6 designated for this purpose.

The Bot scheduler 11 controls how often the intelligent agent Bot gathers information from each site, how often it loads pages from the site while it is gathering the information, and in what order it loads the pages. Since the intelligent agent Bot 10 may reside in more than one computer, and more than one copy of the intelligent agent Bot 10 may be active at any one computer, the Bot scheduler 11 also determines which currently active copy of the intelligent agent Bot 10 is used for each task.

Once the intelligent agent Bot has initially gathered all the information designated in the SSDL site description of a particular Internet site, the site content comparison technician 7 uses the content comparator rule generator 8 to create the content standardization rules 9. The content standardization rules 9 allow information gathered by the intelligent agent Bot 10 to put into a standardized format so that it can be compared against similar information gathered from other Internet sites. On subsequent cycles of gathering information from the same Internet site, the site content comparison technician 7 uses the content comparator rule generator 8 to note any changes that need to be made to the content standardization rules for that Internet site.

After each cycle of the intelligent agent Bot 10 gathering data from an Internet site, and after the site content comparison technician 7 has confirmed that the content standardization rules are up to date for that site, the data interpreter 12 would then use the resulting interpreted information to update the permanent area of the data warehouse 6, and delete the original gathered information. Alternatively, the originally gathered information can be maintained even while updating the particular web site.

The client 17 can view the reports generated from the present invention which are stored in the permanent area of the data warehouse 6. This is accomplished by communicating with the report presentation system 16 via the Internet using a computer. The report presentation system 16 interacts with the client by displaying pages on the client's screen in a consistent, colorful, graphic format. The client can then send information back to the report presentation system 16 by typing text, clicking a mouse on a button, selecting an item from a list or using other graphical user interactions. The layout, graphical format, color format and modes of user interaction for each page are determined by the user graphical interface system 15.

When the client first establishes contact with the report presentation system 16 at the beginning of a report viewing session, the client sends identifying information to the report presentation system. The system then uses this identification information to determine from the client account system 14 if the client is authorized to obtain this information. The client account system 14 also provides the report presentation system 16 with information about which reports are relevant for the particular client to view and about what customization choices have been made by the client for the relevant reports.

The report presentation system provides a client with the opportunity to view or modify some of the kinds of information about the client that are stored by the client account system. When a client makes a request to view or modified such information, the report presentation system 16 uses the client account system 14 to take the appropriate action and relays the results or response to the client.

When the report presentation system 16 receives a request from a client to view a report, it uses the report analysis system 13 to obtain the data it needs for the report from the data warehouse 6 and to process it appropriately. The report presentation system 16 uses the user graphical interface system 15 to format the report, and then sends the report to the client's computer via the Internet.

From the foregoing description, it will be made clear that the present invention may be embodied in other specific forms without departing from the spirit or essential characteristics thereof. The presently disclosed embodiments are therefore to be considered in all respects as illustrative and not restrictive, the scope of the invention being indicated by the appended claims rather than the foregoing description, and all changes which come within the meaning and range of equivalency of the claims are therefore intended to be embraced therein.

What is claimed is:

1. A system for tracking and analyzing data of interest included on the Internet for a particular client comprising:
a data description tool for describing the data of interest on the Internet;
a gathering device for gathering the data of interest utilizing said data description tool;
a data interpreter for interpreting the data of interest gathered by said gathering device; and
a reporting device generating a report of the results of said data interpreter to a client for the data of interest.

2. The system in accordance with claim 1 further including a content comparator rule generator for producing content standardization rules to put said data of interest provided from said gathering device in a standardized format.

3. The system in accordance with claim 1 wherein said reporting device includes a report analysis device for analyzing the data of interest produced by said data interpreter.

4. The system in accordance with claim 2 wherein said reporting device includes a report analysis device for analyzing the data of interest produced by said data interpreter.

5. The system in accordance with claim 1, further including a scheduler for controlling the frequency in which said gathering device gathers the data of interest.

6. The system in accordance with claim 2, wherein said data description tool includes site structure description language and further including a data warehouse for storing said site structure description language and said content standardization rules.

7. The system in accordance with claim 1, further including a graphical interface for allowing the client to view said report.

8. The system in accordance with claim 2, further including a client account system for allowing each client access to said report appropriate to each client.

9. A method of tracking, analyzing and presenting data of interest included on the Internet for a particular client, comprising the steps of:
creating a data description tool for describing the data of interest on the Internet;
gathering data from the Internet utilizing said data description tool;
interpreting said data generated by said gathering step for the data of interest; and
generating a report including the results produced by said interpreting step to a client.

10. The method in accordance with claim 9, further including the steps of:
producing a content comparator set of rules; and
putting said data produced by said gathering step in a standardized format.

11. The method in accordance with claim 9, further including the step of analyzing the data produced by said gathering step prior to generating said report.

12. The method in accordance with claim 10, further including the step of analyzing the data produced by said gathering step prior to generating said report.

13. The method in accordance with claim 9, further including the step of controlling the frequency in which said gathering step gathers the data of interest.

14. The method in accordance with claim 9, wherein said creating step provides a site structure description language for said gathering step.

15. The method in accordance with claim 9, further including the step of requiring the client to provide identification prior to receiving said report.

16. A system for analyzing and presenting information included on a particular Internet web site for a particular client comprising:
a web site description tool for describing the data provided on a particular Internet web site;
a gathering device for gathering data of a particular web site utilizing said web site description tool;
a data interpreter for interpreting the data gathered by said gathering device for each particular Internet web site; and
a reporting device generating a report of the results of said data interpreter to a client for a particular Internet web site, said results including the placement of the particular web site on a search engine as well as navigational information relating to the particular web site.

17. The system in accordance with claim 16, wherein the data gathered from the web site includes placement information and said web site description tool includes site analysis device used to describe the data on the particular web site.

18. The system in accordance with claim 17 further including a content comparator rule generator for producing content standardization rules to put said data provided from said gathering device in a standardized format.

19. The system in accordance with claim 16 wherein said reporting device includes a report analysis device for analyzing data produced by said data interpreter.

20. The system in accordance with claim 18 wherein said reporting device includes a report analysis device for analyzing data produced by said data interpreter.

21. The system in accordance with claim 16, further including a scheduler for controlling the frequency in which said gathering device gathers the data of a particular web site.

22. The system in accordance with claim 18, wherein said web site description tool includes site structure description language and further including a data warehouse for storing said site structure description language and said content standardization rules.

23. The system in accordance with claim 16, further including a graphical interface for allowing the client to view said report.

24. The system in accordance with claim 17, further including a client account system for allowing each client access to said report appropriate to each client.

25. A method of analyzing and presenting information included on a particular Internet web site for a particular client, comprising the steps of:
creating a web site description tool for describing the data provided on a particular Internet web site;
gathering data from the web site utilizing said web site description tool;
interpreting said data generated by said gathering step for each particular web site; and
generating a report including the results produced by said interpreting step to a client for a particular web site, said report including the placement of the particular web site on a search engine as well as navigational information relating to the particular web site.

26. The method in accordance with claim 25, further including the steps of:
producing a content comparator set of rules; and
putting said data produced by said gathering step in a standardized format.

27. The method in accordance with claim 25, further including the step of analyzing the data produced by said gathering step prior to generating said report.

28. The method in accordance with claim 26, further including the step of analyzing the data produced by said gathering step prior to generating said report.

29. The method in accordance with claim 25, further including the step of controlling the frequency in which said gathering step gathers data from a particular web site.

30. The method in accordance with claim 25, wherein said creating step provides a site structure description language for said gathering step.

31. The method in accordance with claim 25, further including the step of requiring the client to provide identification prior to receiving said report.
